(19) United States
(12) Patent Application Publication
(10) Pub. No.: US 2008/0071787 A1
(43) Pub. Date: Mar. 20, 2008

(54) Computer Controlled Display System For Coordinating Many Users Participating In Long Running Processes For Producing Products

(76) Inventor: P. G. Ramachandran, Austin, TX (US)

Correspondence Address: IBM CORPORATION;INTELLECTUAL PROPERTY LAW, 11400 BURNET ROAD, AUSTIN, TX, 78758, US

(21) Appl. No.: 11/530,949

(22) Filed: Sep. 12, 2006

(51) Int. Cl. G06F 17/30

(52) U.S. Cl. 707/9

(57) ABSTRACT

Correlating user actions in a long running process displayed on a computer controlled user interactive display system by an implementation, which, in response to a participating user login into said system, determines the role of said user in said long running process, displays a sequence of steps in the process, including at least the current step and the previous and next steps in the process, limits the data displayed for at least one of the displayed steps in said sequence as defined by said role of said user, and offers the participating user performance options for the current step defined by said role of said user in said long running process.

### TECHNICAL FIELD

The present invention relates to coordinating the activities of the many users participating in production involving long running processes, such as processes having programming functions distributed among users participating in long running processes for computer software product development.

### BACKGROUND OF RELATED ART

The last generation has been marked by a technological revolution driven by the convergence of the data processing and consumer electronics industries together with the explosion of the World Wide Web (Web) or Internet. As a result, extraordinary worldwide communication channels and resources have become available to businesses, and this has forever changed how many businesses and industries develop products, as well as the time cycles of such product development.

Nowhere are these dramatic changes in product development more apparent than in the development, testing and eventual production of computer software products. Over its first forty years prior to the 1980's, the software development environment was one in which an individual or a small dedicated group willing to put in long hard hours could create “elegant” software or “killer applications” directed to and effective in one or more of the limited computer system environments existing at the time.

Unlike hardware or industrial product development, the development of software did not require substantial investment in capital equipment and resources. Consequently, in the software product field, the business and consumer marketplace to which the software is directed has traditionally expected short development cycles from the time that a computer need and demand became apparent to the time that a commercial software product fulfilling the need became available.

Unfortunately, with the explosion of computer usage and the resulting wide diversity of computer systems that must be supported by, or at least not incompatible with, each newly developed computer software product, the development cycles have become very complex. Accordingly, the computer software development industries have been working over the past several years toward the goal of the shortest development cycles with the fewest incompatibilities with standard existing software. One widely used approach to shortening software development cycle times has been to break down or distribute the development and production of complex software products into continuously running development processes. This has been implemented in cooperative programming systems wherein program developers, i.e. participating users could co-act to continuously develop computer program products in distributed program building processes.

In such complex computer program development processes, there is a need to coordinate the many users participating in the development process. It should be understood that these participating users have a diversity of information needs and requirements, e.g. “needs to know” with respect to the development process. Many common development processes frequently involve organizations and individuals having conflicting overall business interests that have combined resources, e.g. “partnered” for a specific product development. Therefore, it is important that while participating users receive all the information they need to complete their tasks, they are unable to access information unnecessary for their work.

### SUMMARY OF THE PRESENT INVENTION

The present invention provides a computer display interface for dynamically tracking and enabling all of the participating users to access all data needed for the effective completion of their tasks in the development process without permitting users to access unnecessary data that may be proprietary to other participating users.

Broadly stated, the invention provides for correlating user activities in a long running process displayed on a computer controlled user interactive display system comprising an implementation, which, in response to a participating user login into said system, determines the role of said user in said long running process, displays a sequence of steps in the process, including at least the current step and the previous and next steps in the process, customizes, e.g. limits the data displayed for at least one of the displayed steps in said sequence as defined by said role of said user, and offers the participating user performance options for the current step defined by said role of said user in said long running process. These options include tasks required to be performed by said participating user during the current step. In addition, the step of customizing the data displayed for a user is preferably carried out for at least the previous step.

The long running process may be a process for the development of complex computer application programs and the steps are steps in the development of these application programs. In such a process, the roles of participating users are determined during the static design of the process for development of the computer application programs. At this early development stage, if there are conflicting business interests involved in the development, all issues of access and “need to know” are preferably resolved. However, should the needs change during the process, the invention enables changes in the roles of said user during the development process.

These development processes have been referred to as long running processes; they are frequently continuous processes. In the case of the development of computer application programs as one version, i.e. the latest version of a computer program is being completed and made available to the public, the next version of the program is already at an earlier developmental stage. Application programs have to be continuously updated with newer versions in response to changes in the computer environment and marketplace for as long as the application program is being marketed. Many hardware product developmental lines are also in similar situations requiring continuous upgrades with input by multiple participants.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of functioning as users' computer controlled display stations on which the display system of the present invention may be interactively accessed;

FIG. 2 is a very generalized view of a network, e.g. Web, portions showing how individual participating users at network display stations may be interconnected with the process manager controlling the distribution of data to the users;

FIG. 3 is a diagrammatic view of a display screen on a computer station illustrating a user at a current step in the process being assigned his tasks and permitted to access data needed to complete current tasks;

FIG. 4 is the display screen view of FIG. 3 but after the user has tried to access data from a previous step;

FIG. 5 is the display screen view of FIG. 4 but after the user has been refused access to data from the previous step;

FIG. 6 is an illustrative flowchart describing the setting up of the process of the present invention for tracking and enabling all of the participating users to access all data needed for the effective completion of their tasks in the development process without permitting users to access unnecessary data; and

FIG. 7 is a flowchart of an illustrative run of the process setup in FIG. 6.

### DETAILED DESCRIPTION OF THE PREFERRED EMBODIMENT

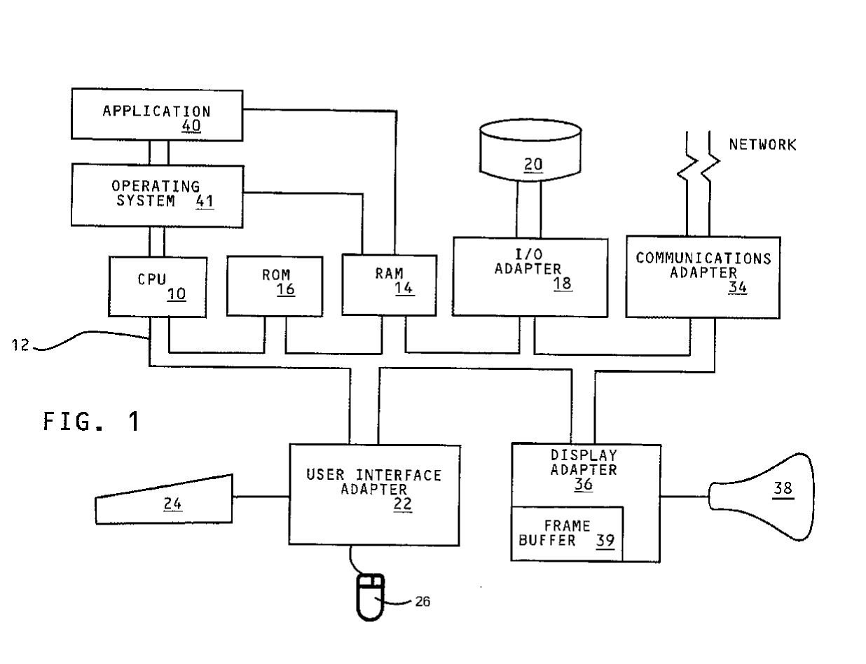

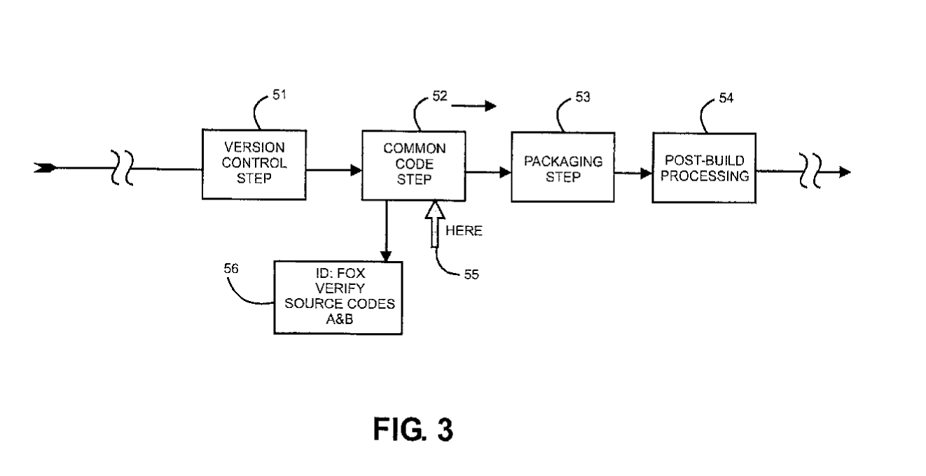

Before FIGS. 3 through 5, related to the overall control of the development process sequential lines for building computer program products, are described in detail, reference is made to FIG. 1, which represents a typical data processing display terminal that may function as the computer controlled display stations through which the participating users may interactively contribute their input into the development process. A central processing unit (CPU) 10, such as one of the PC microprocessors or workstations, e.g. RISC System/6000™ (RS/6000) series available from International Business Machines Corporation (IBM) is provided and interconnected to various other components by system bus 12. An operating system 41 runs on CPU 10, provides control and is used to coordinate the function of the various components of FIG. 1. Operating system 41 may be one of the commercially available operating systems, such as the AIX operating system available from IBM; Microsoft's WindowsMe™ or Windows 2000™, as well as various other UNIX and Linux operating systems. Application programs 40, controlled by the system, are moved into and out of the main memory Random Access Memory (RAM) 14. These programs include the programs of the present invention for coordinating user activities in sequential long running processes in which tasks are distributed among several participating users, to be described hereinafter in greater detail with respect to FIGS. 3 through 5. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20 to provide the storage of the database of the present invention. Communications adapter 34 interconnects bus 12 with an outside network enabling the data processing system to communicate with other such systems over a Local Area Network (LAN) or a Wide Area Network (WAN), which includes the Web or Internet. I/O devices are also connected to system bus 12 via user interface adapter 22 and display adapter 36. Keyboard 24 and mouse 26 are all interconnected to bus 12 through user interface adapter 22. Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

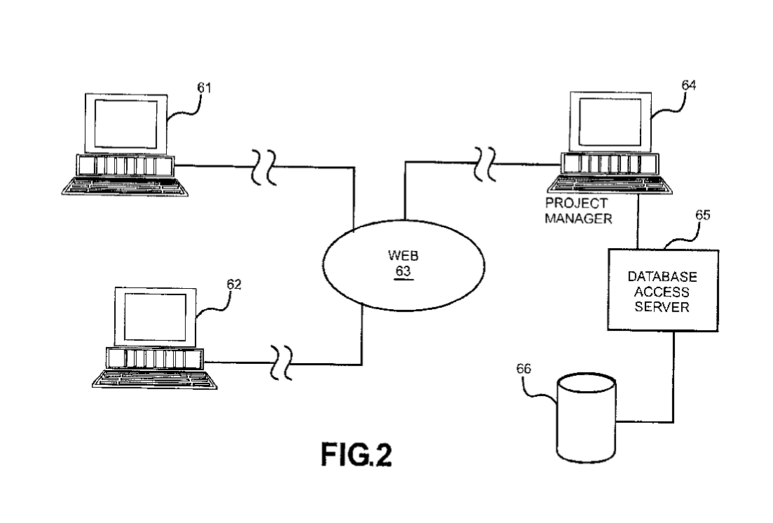

Referring now to FIG. 2, there is illustrated a very generalized view of a network, e.g. Web, portions showing how individual participating users at network display stations may be interconnected with the process manager controlling the distribution of data to the users. A plurality of computer controlled display stations, e.g. stations 61 and 62, are shown connected in a network arrangement, e.g. Web, via network servers (not shown). Stations 61 and 62 are representative of display terminals with each respective terminal associated with one of the plurality of the participating users who contribute their input to the sequential continuous process producing an overall software product. A representative display of a portion of a sequential development process is displayed in FIG. 3, which will be subsequently described in greater detail. Dependent upon the extent of the distribution of tasks to a participating user involved in the software program development process, the network of FIG. 2 may be a local area network (LAN) or a wide area network (WAN), including, of course, the Web 63. The sequential processes of the present invention, particularly the participating users input and the data provided to such interactive users, is controlled by a project manager at computer site 64, appropriately connected to the Web 63 managing the data and task distribution of the present invention stored under the control of the project manager in database 66 accessed through server 65.

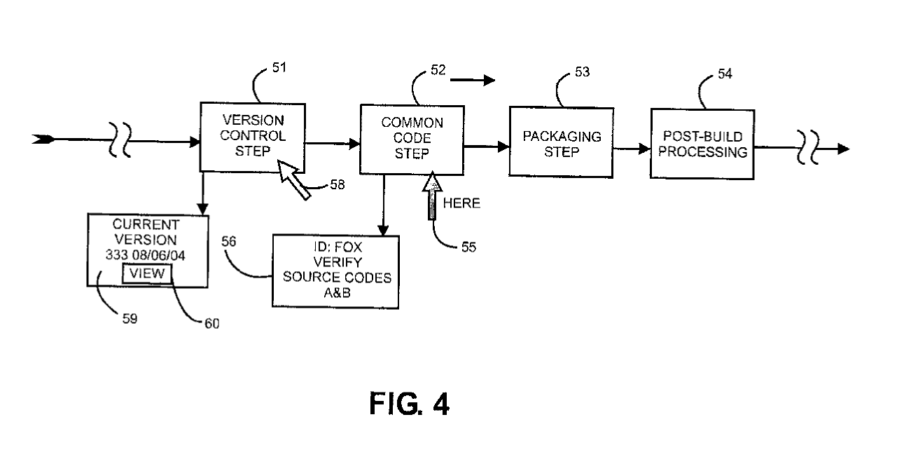

With reference to FIG. 3, there is shown a diagrammatic view of a display screen on a computer station illustrating a user at a current step in the process being assigned his tasks. The portion of the sequential process shown on the user's display screen includes the current step 52, “Common Code Step”, as indicated by “HERE” marker 55, the previous step, “Version Control Step” 51, and the next two steps in the process, “Packaging Step” 53, and “Post Build Processing” 54. The user who has just logged-in is advised of the current step by the Here marker 55, where his ID: Fox is confirmed and he is assigned his tasks: “to Verify Source Codes A and B” in box 56. In this illustration, the user believes that he requires some data about the previous step 51. Therefore, in FIG. 4, which shows the same display screen, he has moved the usual mouse controlled cursor 58 to step 51, selected the step for further information and, in box 59, he is given the identifier of the current version with a view button 60 through which he may request to view the current version.

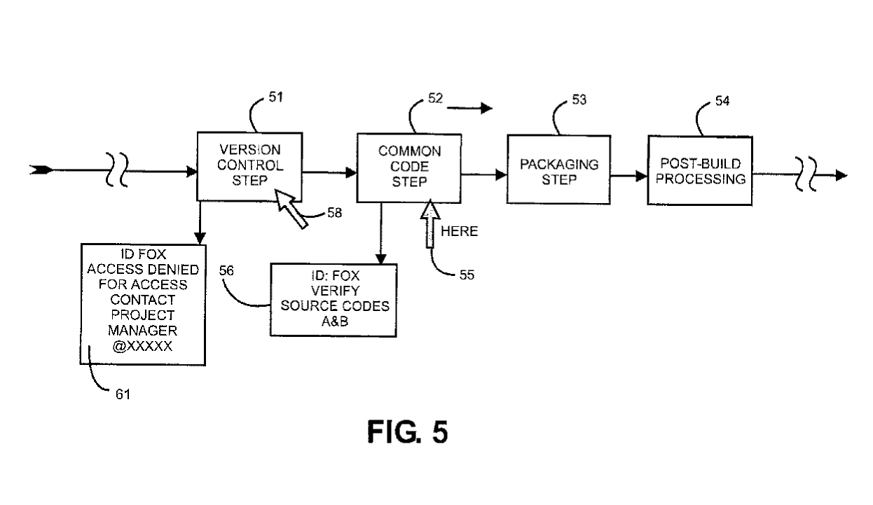

However, as shown in FIG. 5, the response from the system in box 61 indicates that the user ID: Fox has been denied access. In this example, the user has been advised by text that he is denied access. Other expedients, such as masking the denied data, may be used to show that there is a denial of access. For example, the categories of denied data may be shown but conventionally grayed out to indicate the type of data to which access is denied. This graying out may be used for all of the steps displayed to the user. This would enable the user to obtain an overall view on what is being denied to him so that he could then determine whether any additional access is warranted.

This denial of access in FIG. 5 is probably based on a predetermination that ID: Fox does not have a need to know the additional information with respect to previous step 51. The predeterminations as to which participating users will have access to which information is made during the design of the process in which the designers, with as full an understanding as possible of the general proprietary interests of organizations involved in the development process for producing the product, determine the information “needs to know” of each participating user. Based upon such predeterminations, appropriate masking of the data associated with each step in the process may limit access of each user based upon such “need to know”. In long running processes, access to information related to a particular step may be time dependent. The designers of the long running process may have determined that access to information for longer than reasonable time periods may compromise security, e.g. an user unauthorized to make copies may be making copies in violation his authority. Also, the time factor may be involved as to when a user may have access to information. For example, a user may have access to certain information until the development process is expected to reach a certain point in time when it is predetermined that the user will need to know the data involved.

There may be circumstances where a user is denied access to information relative to a particular step because another participant in the continuous process has not performed a required task. For example, when another participant, i.e. user, has been delinquent in updating certain data related to a step. Under such circumstances, the user may have been denied access because the data still available for the step would be outdated and wrong.

Where some access is denied, the user prompt box 61 further advises the user as to how and who to contact in order to change his denied information status. If the user convinces the process manager, then the user's status may be dynamically changed during the continuously proceeding process. In the example given above where a user is denied access based on the failure of another user to perform certain functions, the denied user may be advised, e.g. by prompt box 61, of this failure. This would enable the user to go directly to the delinquent user to request that the required functions be performed.

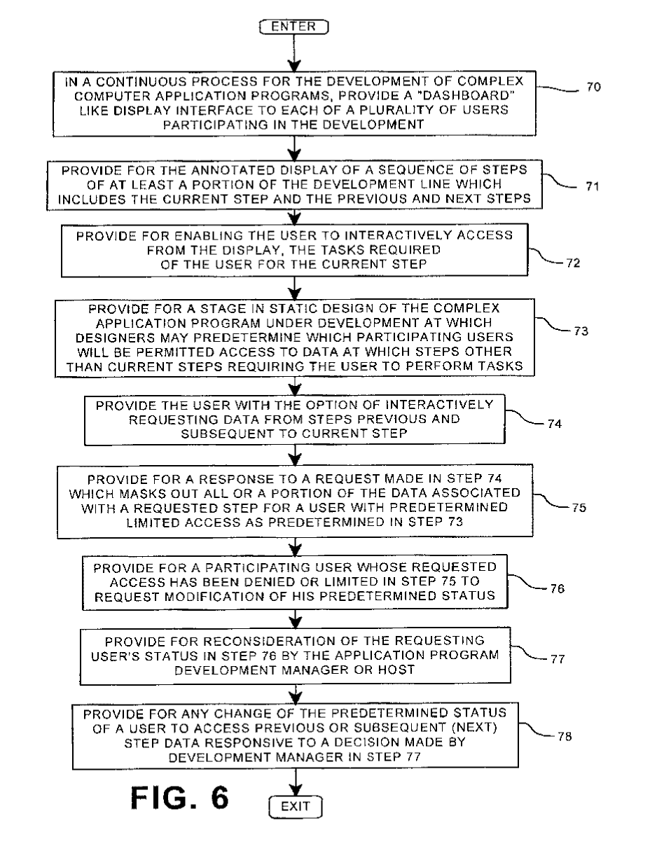

Now, with reference to FIG. 6, we will describe the setting up or development of a program according to the present invention for orienting a participating user and coordinating user activities in sequential long running processes in which tasks are distributed among several participating users. In a continuous process for the development of complex computer application programs, there is provided a “Dashboard” like display interface to each of a plurality of users participating in the development, step 70. On such a Dashboard interface, provision is made, step 71, for the annotated display of a sequence of steps of at least a portion of the development line that includes the current step and the previous and next steps. Provision is made, step 72, for enabling the user to interactively access from the display, the tasks required of the user for the current step. A stage is provided in the static design of the complex application program development process at which the designers may predetermine which participating users will be permitted access to data at which steps other than the current step that requires the user to perform tasks, step 73. The user is provided, step 74, with the option of requesting data from steps previous and subsequent to the current step. Provision is made, step 75, for a response to a request made in step 74 that involves masking out all or a portion of the data associated with a requested step for a user with predetermined limited access as predetermined in step 73. Provision is made, step 76, for a participating user whose requested access has been denied or limited in step 75 to request modification of this predetermined status. Provision is made, step 77, for reconsideration of the requesting user's status in step 76 by the application program development manager or host with that responsibility. Provision is made, step 78, for implementing any change of the predetermined status of a user to access previous or subsequent step data resulting from a decision made in step 77.

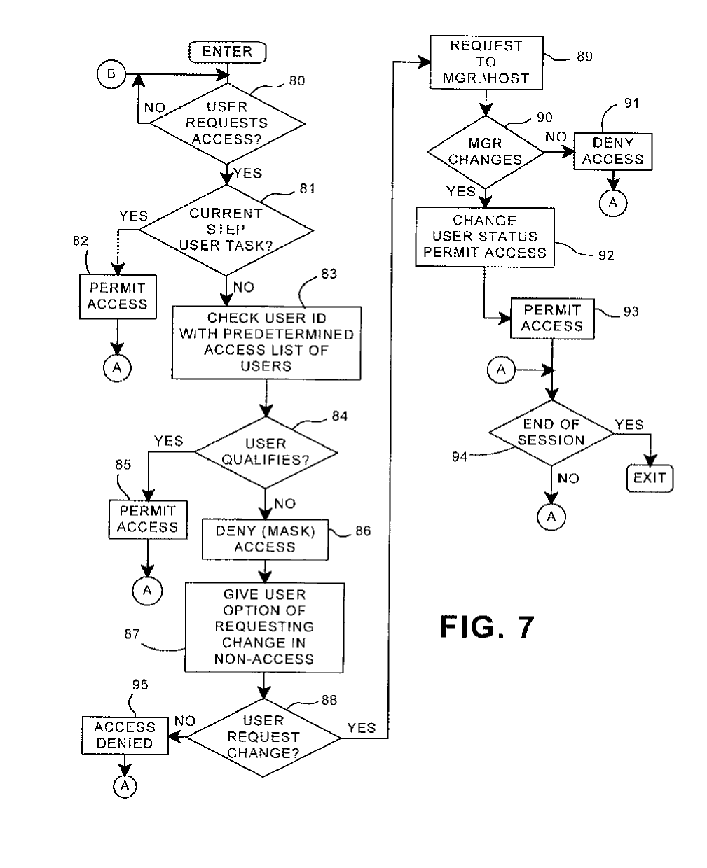

Now that the basic program set up has been described, there will be described with respect to FIG. 7 a flowchart of a simple operation showing how the program could be run. During the running of the continuous process, a determination is made as to whether a user has requested access to a particular step in the process, step 80. If Yes, a further determination is made as to whether the step to which access is requested is the current step, which requires the user to perform tasks, step 81. If Yes, access is permitted, step 82. If the decision in step 81 is No, then the user is requesting access to a step other than the current step. The user ID is then checked with the list permitting predetermined limited access to the participating users for the particular step requested, step 83. Then a determination is made, step 84, as to whether the user qualifies to access the data associated with the requested step. If Yes, access is permitted, step 85. If No, step 86, access is denied in whole or in part; the associated data is appropriately masked. At this point, a user with denied access is permitted to optionally request a change in his predetermined access status, step 87, and a determination is made as to whether the user has requested such a change, step 88. If No, his access remains denied, step 95. If Yes, then step 89, his request is sent to the process manager or host and a determination is made, step 90, as to whether the manager has changed the user's access status.

If No, access is still denied, step 91. If Yes, the predetermined user status is changed to permit access, step 92, and access is then permitted, step 93. At this point, or after any of steps 82, 85, 95 and 91, via Branch “A”, a determination may conveniently be made as to whether the session is at an end, step 94. If Yes, the session is exited. If No, the session is returned to initial step 80 via branch “B”.

One of the implementations of the present invention may be in application program 40 made up of programming steps or instructions resident in RAM 14, FIG. 1, of a Web receiving station during various Web operations. Until required by the computer system, the program instructions may be stored in another readable medium, e.g. in disk drive 20 or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Web itself, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. A method for correlating user actions in a long running process displayed on a computer controlled user interactive display system comprising:
responsive to said participating user login into said system, determining the role of said user in said long running process;
displaying a sequence of steps in the process including at least the current step and the previous and next steps in the process;
customizing the data displayed for at least one of the displayed steps in said sequence as defined by said role of said user; and
offering said participating user performance options for said current step defined by said role of said user in said long running process.

2. The method of claim 1 wherein the options offered to said participating user include tasks required to be performed by said participating user during said current step.

3. The method of claim 1 wherein said step of customizing the data displayed for a user is carried out by masking at least a portion of displayable available data for said step.

4. The method of claim 1 wherein said step of customizing the data displayed for a user is carried out for at least the previous step.

5. The method of claim 1 wherein:
said long running process is a process for the development of complex computer application programs; and
said steps are steps in the development of said application programs.

6. The method of claim 5 wherein the roles of participating users are determined during the static design of said process for development of said computer application programs.

7. The method of claim 6 further including the step of enabling changes in the roles of said user during the development of said computer application programs.

8. A computer controlled system for correlating user actions in a long running process displayed on a user interactive display system comprising:
means, responsive to said participating user login into said system, for determining the role of said user in said long running process;
means for playing a sequence of steps in the process including at least the current step and the previous and next steps in the process;
means for customizing the data displayed for each of the displayed steps in said sequence as defined by said role of said user; and
means for offering to said participating user performance options for said current step defined by said role of said user in said long running process.

9. The system of claim 8 wherein the options offered to said participating user include tasks required to be performed by said participating user during said current step.

10. The system of claim 8 wherein said means for customizing the data displayed for a user includes means for masking at least a portion of displayable available data for said step.

11. The system of claim 8 wherein said means for customizing the data displayed for a user customize at least said previous step.

12. The system of claim 8 wherein said long running process is a process for the development of complex computer application programs.

13. The system of claim 8 wherein said means for customizing customize the data displayed for each of the displayed steps in said sequence as defined by the role of the user.

14. The system of claim 10 wherein said means for masking gray out at least a portion of displayable available data for said step.

15. A computer program having code recorded on a computer readable medium for correlating user actions in a long running process displayed on a user interactive display system comprising:
means, responsive to said participating user login into said system, for determining the role of said user in said long running process;
means for playing a sequence of steps in the process including at least the current step and the previous and next steps in the process;
means for customizing the data displayed for each of the displayed steps in said sequence as defined by said role of said user; and
means for offering to said participating user performance options for said current step defined by said role of said user in said long running process.

16. The computer program of claim 15 wherein the options offered to said participating user include tasks required to be performed by said participating user during said current step.

17. The computer program of claim 15 wherein said means for customizing the data displayed for a user includes means for masking at least a portion of displayable available data for said step.

18. The computer program of claim 15 wherein said means for customizing the data displayed for a user customize at least said previous step.

19. The computer program of claim 15 wherein said long running process is a process for the development of complex computer application programs.

20. The computer program of claim 15 further including means for enabling changes in the roles of said user during the development of said computer application programs.
